(19) United States
(12) Patent Application Publication
(10) Pub. No.: US 2019/0191229 A1
(43) Pub. Date: Jun. 20, 2019

(54) CABINET AND PATCHCORD MANAGEMENT PANEL

(71) Applicant: COMMSCOPE TECHNOLOGIES LLC, Hickory, NC (US)

(72) Inventors: Scott C. KOWALCZYK, Savage, MN (US); Soutsada VONGSENG, Chanhassen, MN (US); Jackson Ray POMROY, Minnetonka, MN (US); Kenneth C. HALL, Lafayette Hill, PA (US); Jonathan R. KAML, Shakopee, MN (US)

(21) Appl. No.: 16/327,562

(22) PCT Filed: Aug. 22, 2017
(86) PCT No.: PCT/US2017/047987

§ 371 Date: Feb. 22, 2019

Related U.S. Application Data
(60) Provisional application No. 62/378,093, filed on Aug. 22, 2016.
(60) Provisional application No. 62/412,611, filed on Oct. 25, 2016.
(60) Provisional application No. 62/415,218, filed on Oct. 31, 2016.

(51) Int. Cl. H04Q 1/06

(52) U.S. Cl. CPC H04Q 1/066; H04Q 1/062

(57) ABSTRACT

A telecommunications panel or bracket assembly includes a frame for hingedly mounting to a telecommunications cabinet. The panel includes a plurality of telecommunications modules with one or more front ports and one or more rear ports for telecommunications cables. Patch cords connect from the front ports of the modules to equipment held by the cabinet. Trunk cables or other cables connect to the rear ports of the modules. The panel is hingedly mounted to the side of the cabinet to access the rear ports and the trunk cables.

### CROSS-REFERENCE TO RELATED APPLICATIONS

This application is being filed on Aug. 22, 2017 as a PCT International Patent Application and claims the benefit of U.S. Patent Application Ser. No. 62/378,093, filed on Aug. 22, 2016, and claims the benefit of U.S. Patent Application Ser. No. 62/412,611, filed on Oct. 25, 2016, and claims the benefit of U.S. Patent Application Ser. No. 62/415,218, filed on Oct. 31, 2016, the disclosures of which are incorporated herein by reference in their entireties.

### BACKGROUND

Telecommunications frames, racks, and cabinets are used to hold telecommunications equipment and/or connectivity devices. Various cables connect the telecommunications equipment with other equipment, panels, and outlets. There is a continuing need for managing the cables extending to and from the telecommunications frames, racks, and cabinets. In one example, patch cords are used to link equipment. The cables, including the patch cords, can be copper based, fiber based, or hybrid cables.

### SUMMARY

One aspect of the present invention relates to a panel or bracket assembly which includes a frame defining various openings. In one example embodiment, the openings are provided in a vertical column extending from a top of the panel toward a bottom of the panel. Along one side of the frame, a hinge is provided for hingedly mounting the panel to a telecommunications frame, rack, or cabinet. Modules are positioned in the openings as desired. The modules typically have one or more front ports, and one or more rear ports defining termination locations for telecommunications cables. The front and rear ports receive telecommunications plugs, connectors, and other cable terminating devices. The front or rear ports can be jacks, adapters or other cable connection devices.

Other aspects of the disclosure include a channel frame assembly including a frame defining a cable channel, a bracket assembly mounted to the cable channel to selectively block access to the cable channel, and one or more termination modules carried by the bracket assembly. The bracket assembly may pivot relative to the cable channel between open and closed positions. At least one port and/or termination of the termination module is accessible within the cable channel and at least another port and/or termination of the termination module is accessible from outside of the cable channel when the bracket is closed. The channel frame assembly may be mounted within a telecommunications cabinet and/or to a telecommunications rack.

In one aspect of the invention, the panel is mounted to a cabinet (also a rack or frame) wherein the cabinet holds telecommunications equipment. In one example embodiment, the equipment is mounted to the cabinet extending from the front (or first side) of the cabinet toward a back (or second side) of the cabinet. The panel can be mounted to the cabinet to manage the cabling within the cabinet on the front side, or the back side. In one example embodiment, the panel is mounted to a side of the cabinet between the front and the back.

In one example, the panel is mounted to one side of the cabinet wherein a front of the panel faces the opposite side of the cabinet.

In one example embodiment, the panel hinges between a closed position, and an open position. In the open position, a rear of the frame is exposed to the front (or back) of the cabinet to allow access to the rear ports of the modules mounted to the panel.

In one example arrangement, patch cords extend from the modules of the panel to the equipment mounted in the cabinet. The patch cords extend from the front ports of the modules.

In one example embodiment, trunk cables or other cables extend within the cabinet between a side of the cabinet and a back of the frame of the panel. The trunk cables or other cables connect to the rear ports of the modules.

With a hingedly mounted frame of the panel, a user can access the rear ports of the modules to connect the trunk cables or other cables to the rear ports. Once closed, the frame of the panel is positioned facing the opposite side of the cabinet.

In one embodiment, the modules are mounted at an angle relative to the frame wherein the connection axis defined by the front ports or the rear ports or both. The front and rear ports are at an angle relative to both a horizontal plane and a vertical plane. In one example, the modules angle downwardly. Other examples include upwardly angled modules.

The panel can also take the form of a standalone unit with a pivoting front frame mounted to a rear housing portion for mounting within a cabinet, or other structures.

Latches can be provided to hold the pivoting panel or frame in the closed position.

The modules can mount to the panel or frame with angled blocks. The blocks can be added at or around the time of assembly of the panel to the cabinet. Such a construction allows the panel to be mounted on either the right side or the left side of the cabinet. The blocks can then appropriately angle the modules in the desired direction, such as downward. Also, the panel or frame can be shipped more compactly without the modules mounted to the panel or frame.

### BRIEF DESCRIPTION OF THE DRAWINGS

FIGS. 1-15 show various features of an example embodiment of a cabinet including telecommunications equipment, and a panel or bracket assembly for holding telecommunications modules. Various cables are shown connecting to the modules, and connecting the modules to the equipment.

FIGS. 16-19 show another example embodiment of a panel or bracket assembly for holding telecommunications modules.

FIGS. 20-22 show a further example embodiment of a panel or bracket assembly for holding telecommunications modules.

FIGS. 23-32 show a further example embodiment of a panel or bracket assembly for holding telecommunications modules.

FIGS. 33-42 show further views of the module mounting blocks.

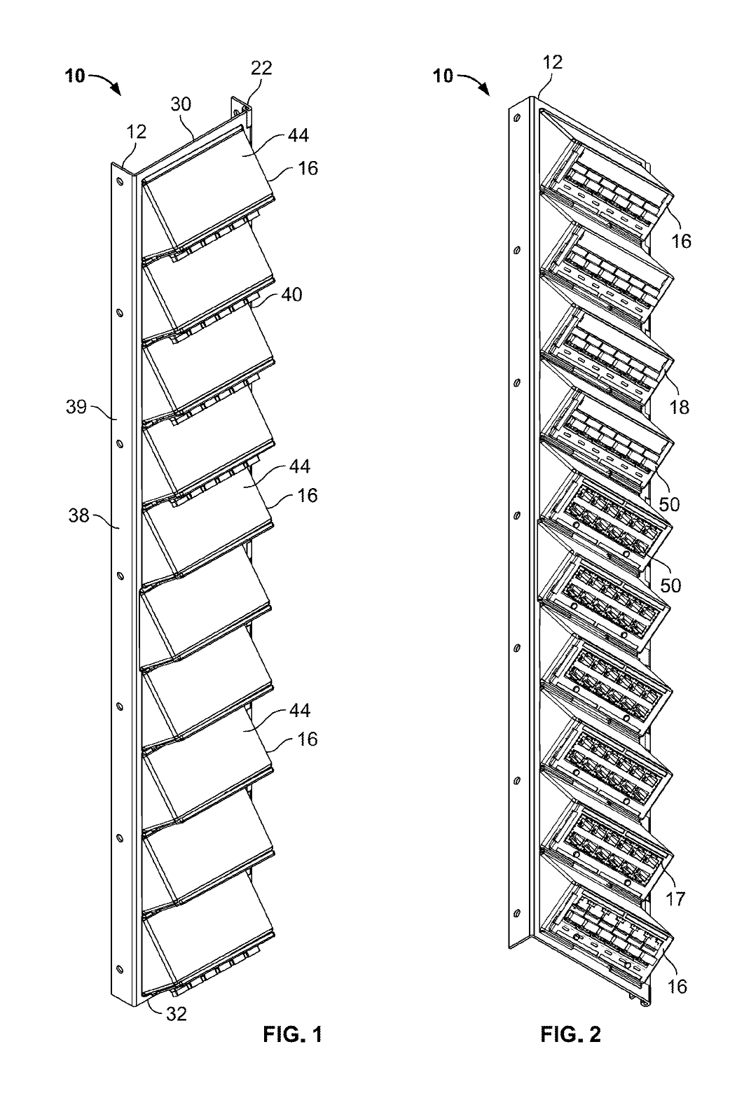

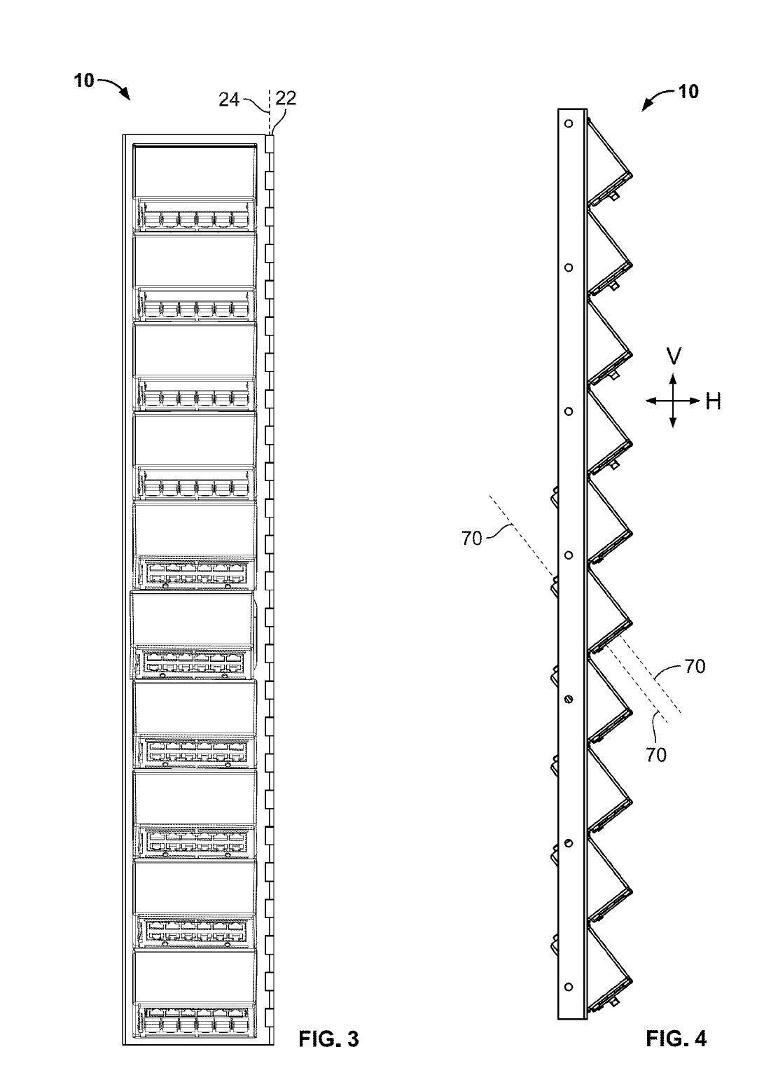

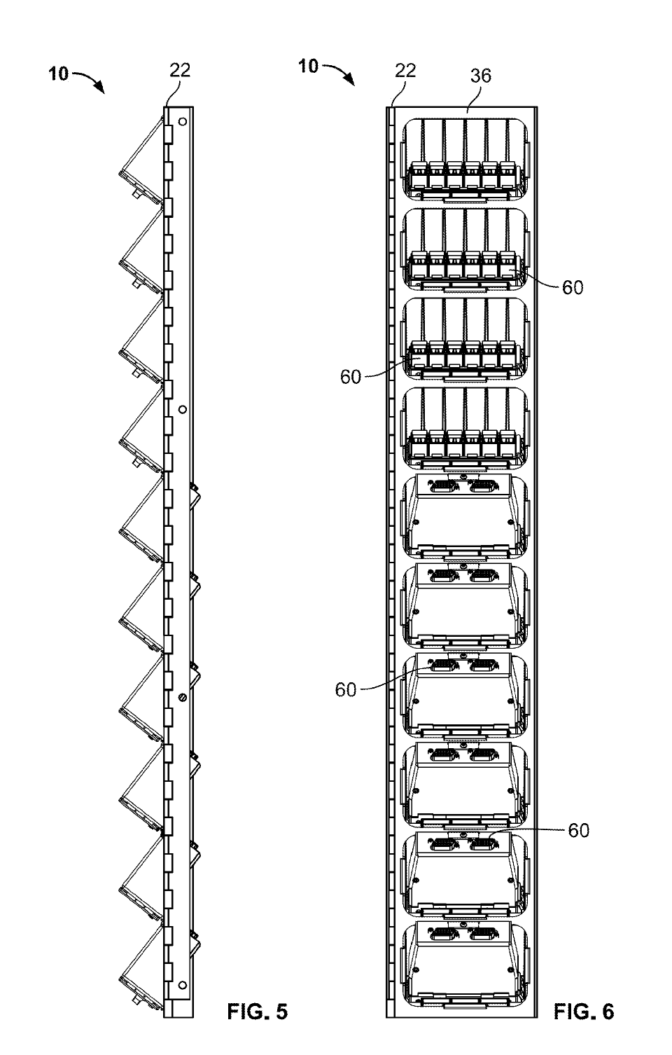

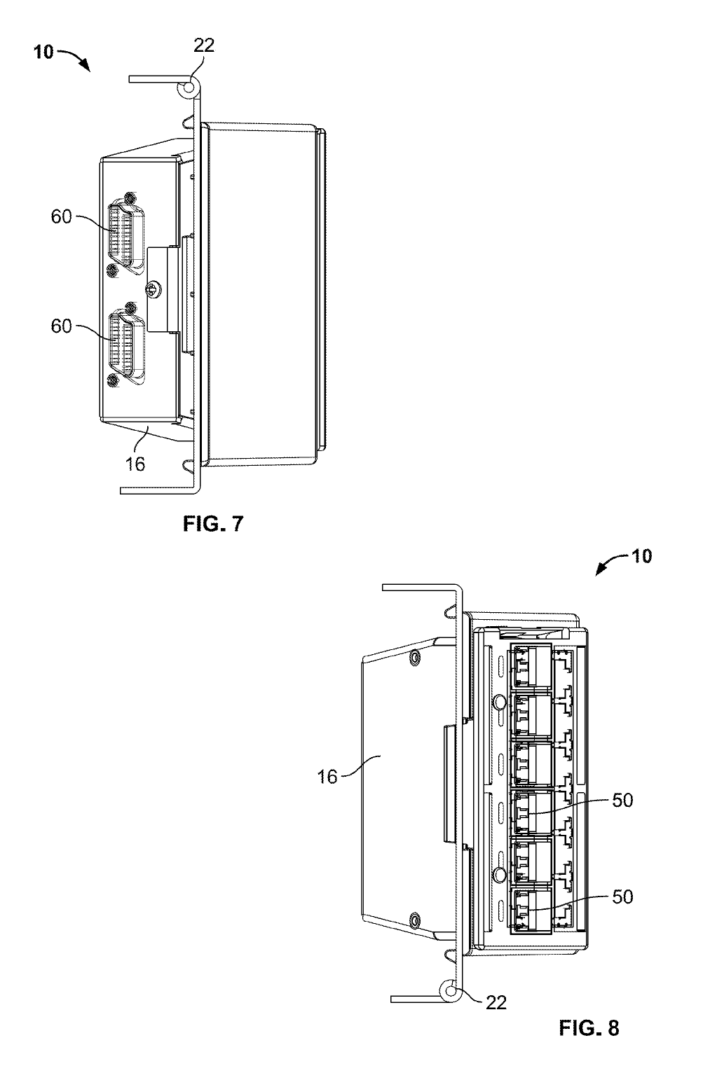

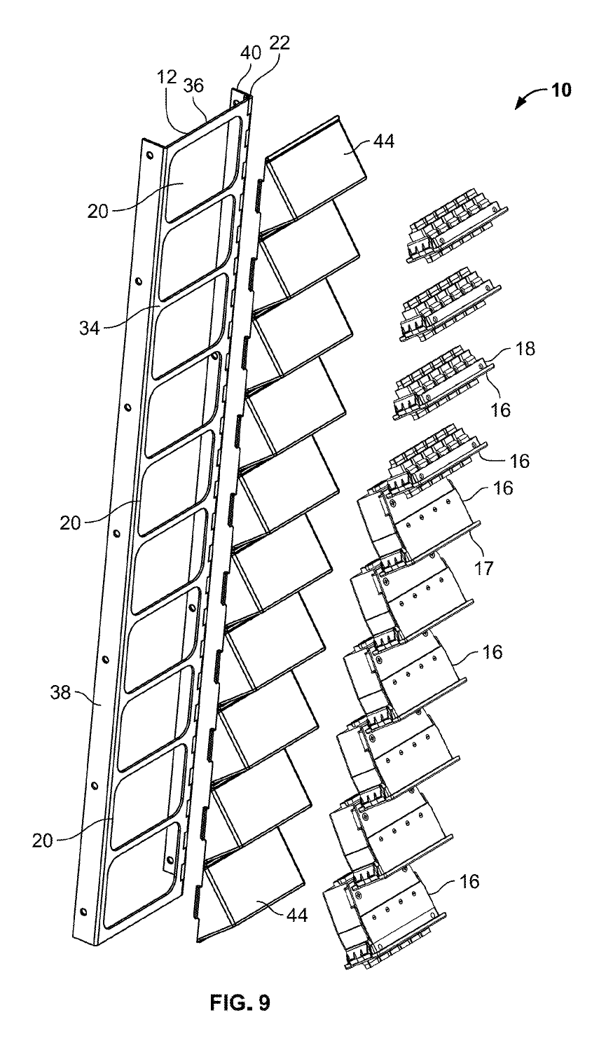

### DETAILED DESCRIPTION

Referring to the FIGS., a panel or bracket assembly 10 includes a frame 12 defining various openings 20. In one example embodiment, the openings 20 are provided in a vertical column extending from a top 30 of the panel toward a bottom 32 of the panel. Along one side 40 of the frame 12, a hinge 22 is provided for hingedly mounting the panel to a telecommunications frame, rack, or cabinet (hereinafter “cabinet”). Modules 16 are positioned in the openings 20 as desired. The modules 16 typically have one or more front ports 50, and one or more rear ports 60 defining termination locations for telecommunications cables. The front and rear ports 50, 60 receive telecommunications plugs, connectors, or other cable terminating devices. The front and rear ports 50, 60 can be jacks, adapters or other cable connection devices. The modules 16 can be breakout modules, splitter modules, or other modules. As shown, copper modules 17 are on one area of panel 10, and fiber modules 18 are mounted in another area. Other arrangements are possible.

The panel 10 is shown mounted to a cabinet 100 (also a rack or a frame) wherein the cabinet 100 holds telecommunications equipment 120. In one example embodiment 120, the equipment is mounted to the cabinet extending from the front 168 (or a first side) of the cabinet toward a back 170 (or a second side) of the cabinet. The panel 10 can be mounted to the cabinet 100 to manage the cabling within the cabinet on the front side (or the back side). In one example embodiment, the panel is mounted to a side wall 164 of the cabinet between the front 168 and the back 170. It is to be appreciated that front 168 and back 170 are labels in this example and could be reversed in other examples.

Cabinet 100 also includes two posts 102, 104. Cabinet 100 includes a top 160, a bottom 162, and sides or side wall 164, 166. Side walls 164, 166 extend generally in the direction of front to back (or back to front).

As shown, the panel 10 is mounted to one side 164 of the cabinet 100 wherein a front 34 of the panel faces the opposite side 166 of the cabinet.

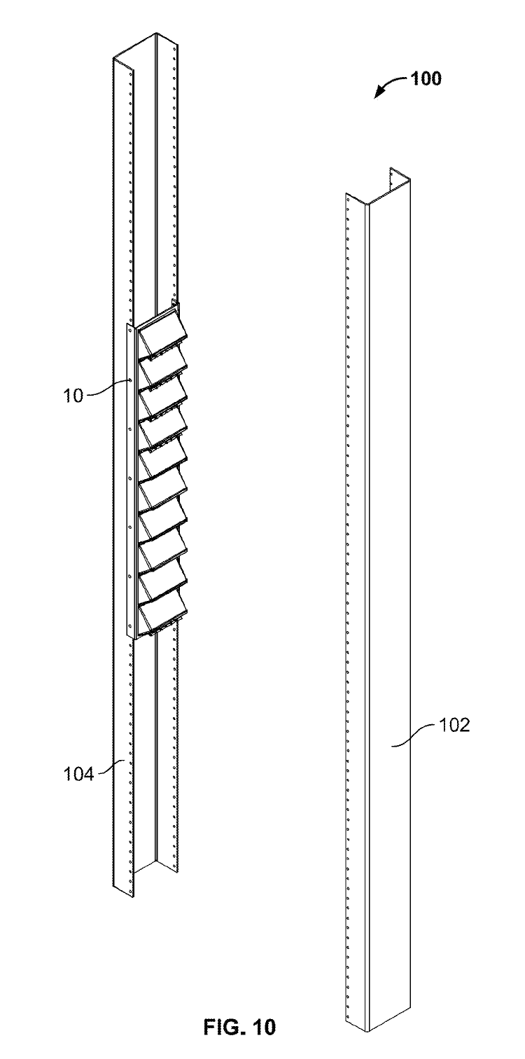

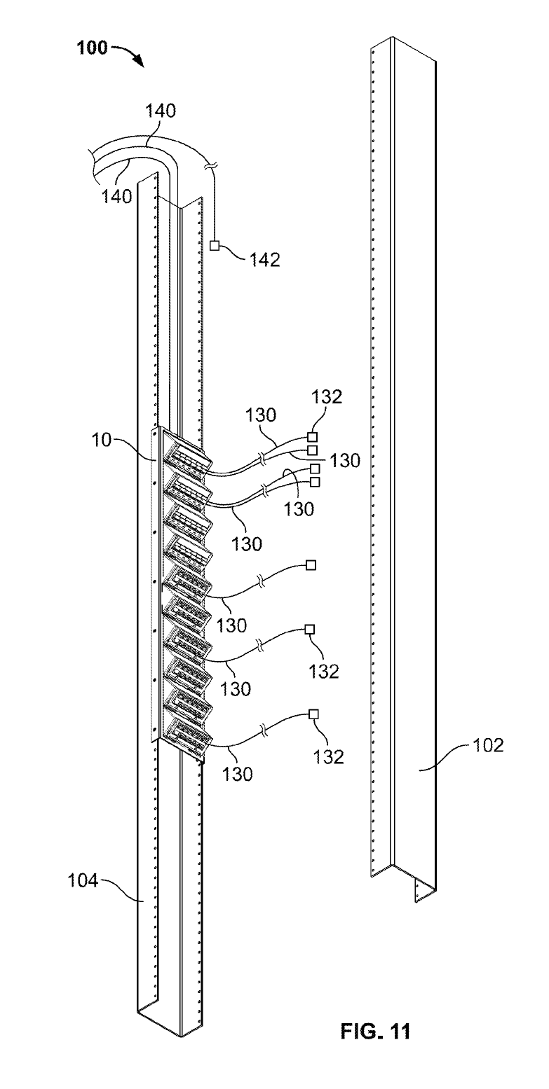

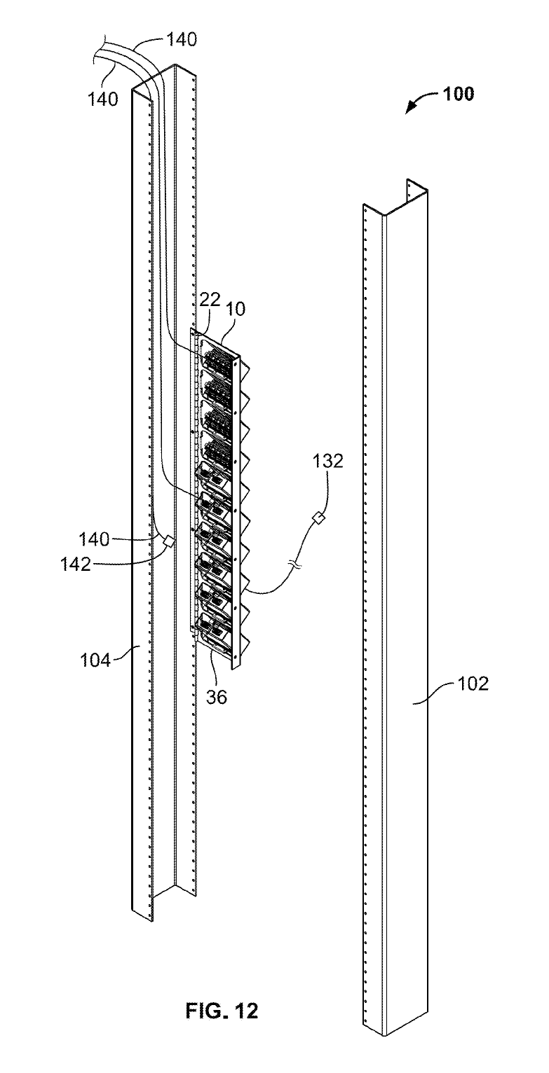

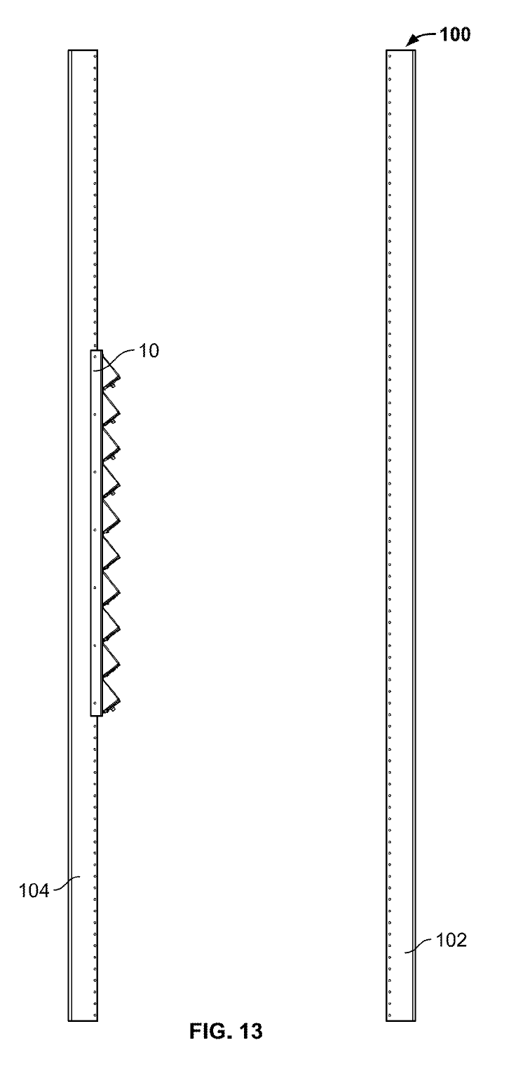

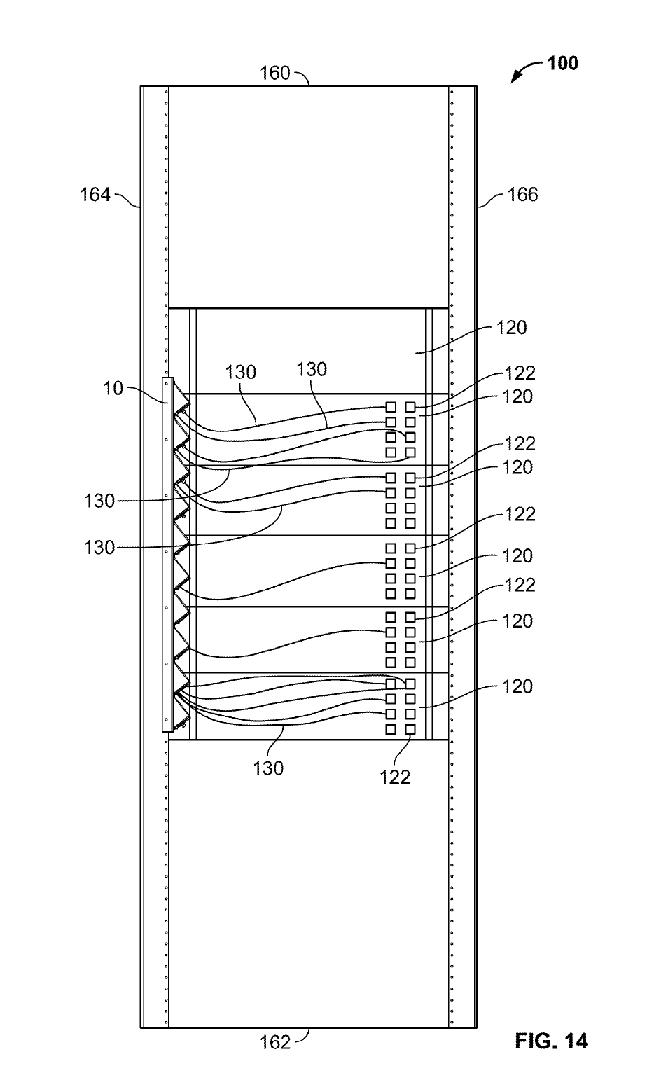

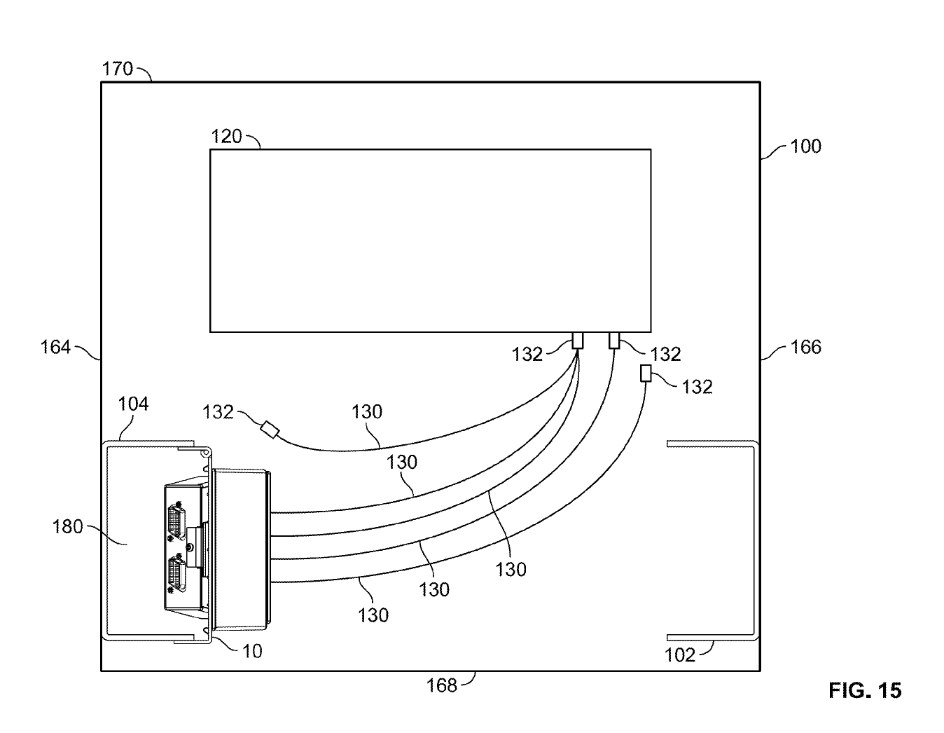

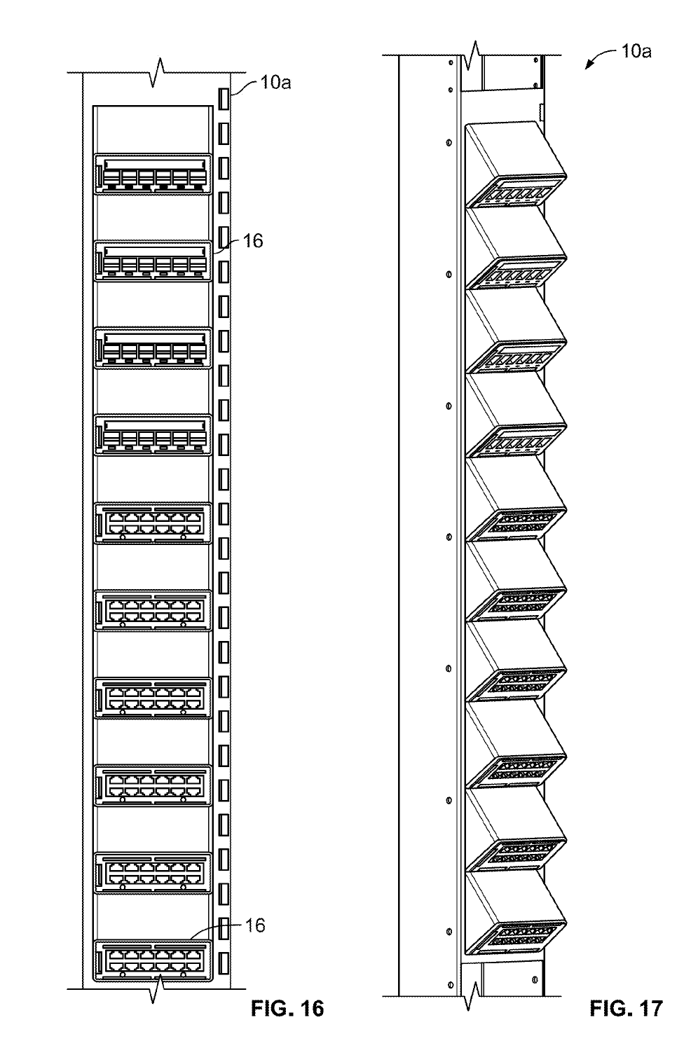

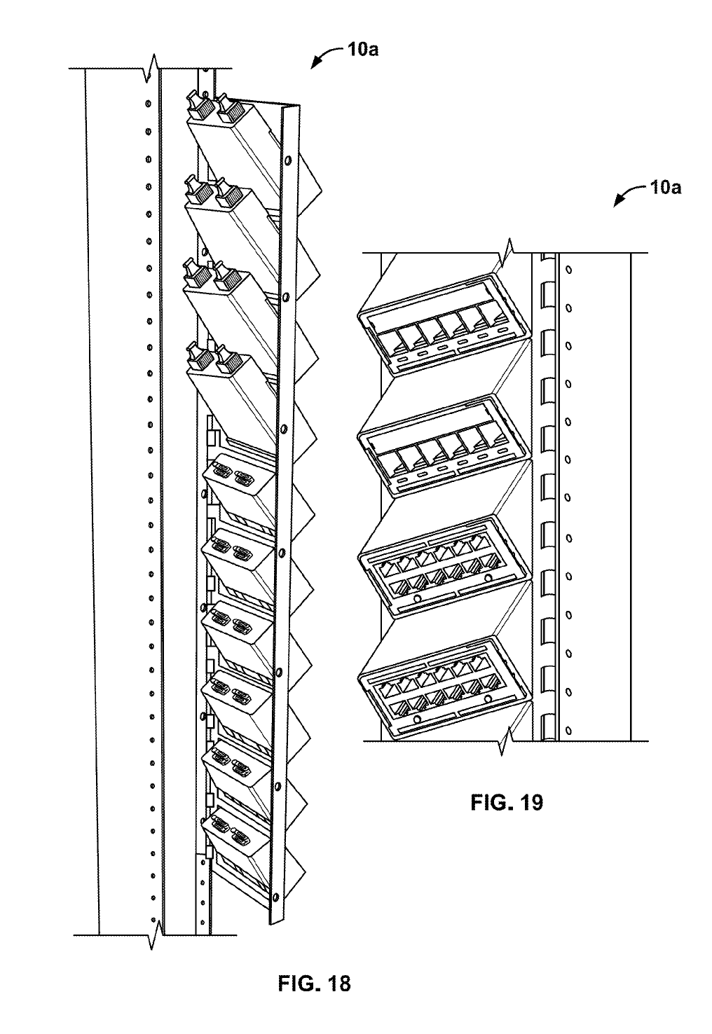

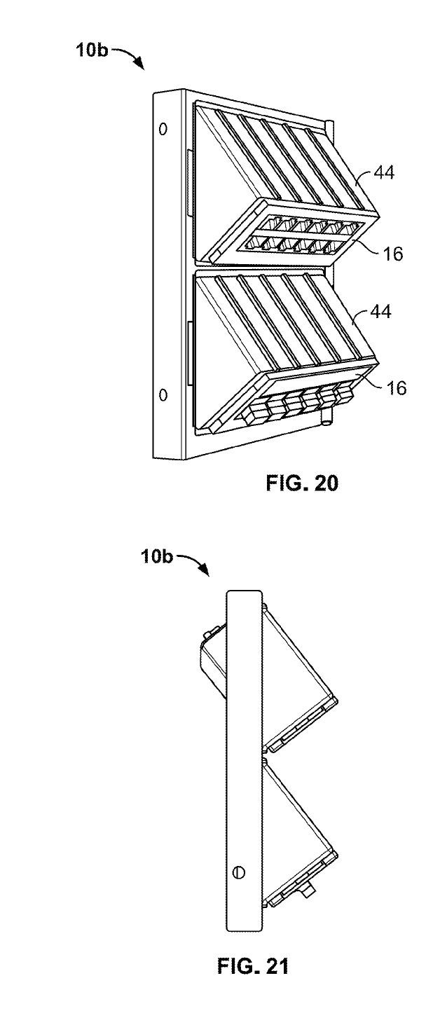

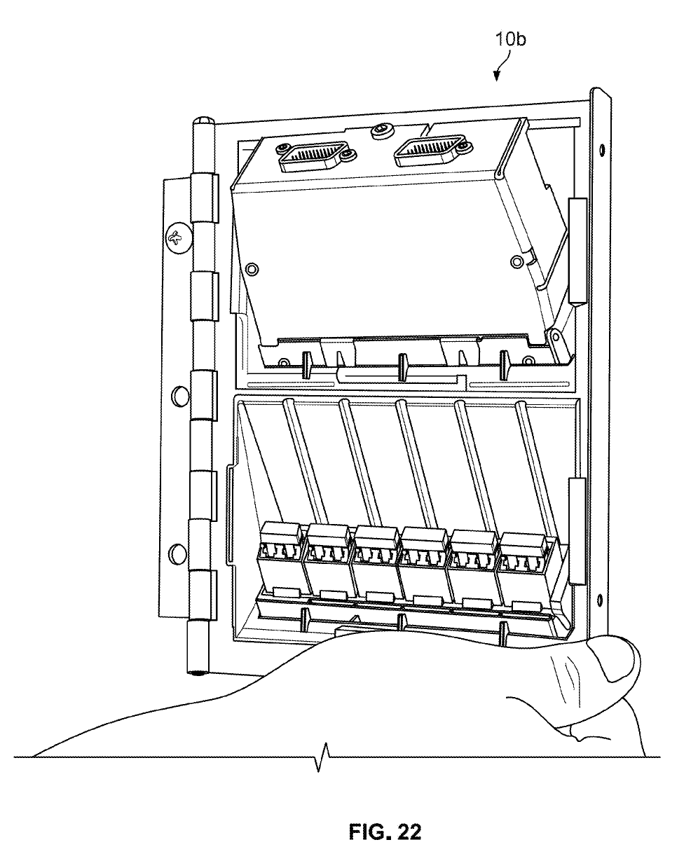

The panel 10 preferably hinges about axis 24 between a closed position, and an open position. Compare FIGS. 10 and 12. In the open position, a back 36 of the frame 12 is exposed to the front (or back) of the cabinet 100 to allow user access to the rear ports 60 of the modules 16 mounted to the panel. A cable passage 180 is also created by cabinet 100 and panel 10.

In one example arrangement, patch cords 130 extend from the modules 16 of the panel 10 to the equipment 120 mounted in the cabinet 100. The patch cords 130 extend from the front ports 50 of the modules to ports 122 on equipment 120. Patch cords 130 are terminated on each end 132 by plugs, connectors or other cable terminating devices.

In one example embodiment, trunk cables or other cables 140 extend within the cabinet between a side 164 of the cabinet and a back 36 of the frame 12 of the panel 10. The trunk cables or other cables connect to the rear ports of the modules with plugs, connectors or other cable terminating devices on end 142 of each trunk cable.

With a hingedly mounted frame of the panel, a user can access the rear ports 60 of the modules 16 to connect the trunk cables 140 or other cables to the rear ports. Once closed, the frame 12 of the panel is positioned facing the opposite side of the cabinet.

In one embodiment, the modules 16 are mounted at an angle relative to the frame wherein the connection axis 70 defined by the front ports or the rear ports or both. The front and rear ports are at an angle relative to both a horizontal plane and a vertical plane. In one example, the modules angle downwardly. Other examples include upwardly angled modules. Block 44 mounts each module 16 to frame 12 to create the angled mounting arrangement.

Panel 10 with frame 12 has a top 30, a bottom 32, a front 34, a back 36, and sides 38, 40. Side 38 defines a flange 39 which can be latched or mounted to cabinet 100 in the closed position. Hinge 22 includes a side 40 in the form of a panel that mounts to the cabinet 100, but allows hingeable movement of the rest of frame 12.

Panel 10 in the example cabinet 100 allows for shorter patch cords 130 that link to nearby modules 16 relative to the equipment 120. Such a shorter length may lead to easier installations, especially if there are many connections to the equipment. In the case of longer patch cords, such as patch cords that extend to another frame, rack of cabinet, where the patch cords extend from a patch panel, there can be increased risk of damage to the patch cords or misconnections to the equipment.

Modules 16 in the examples shown can easily be customized to each user's needs by populating only those types of modules needed in that cabinet 100.

Trunk cables 140 can easily be connected to the rear ports due to the easy accessibility by the hinge.

Modules 16 are mounted in a manner that does not take cabinet spacing that is needed for the equipment.

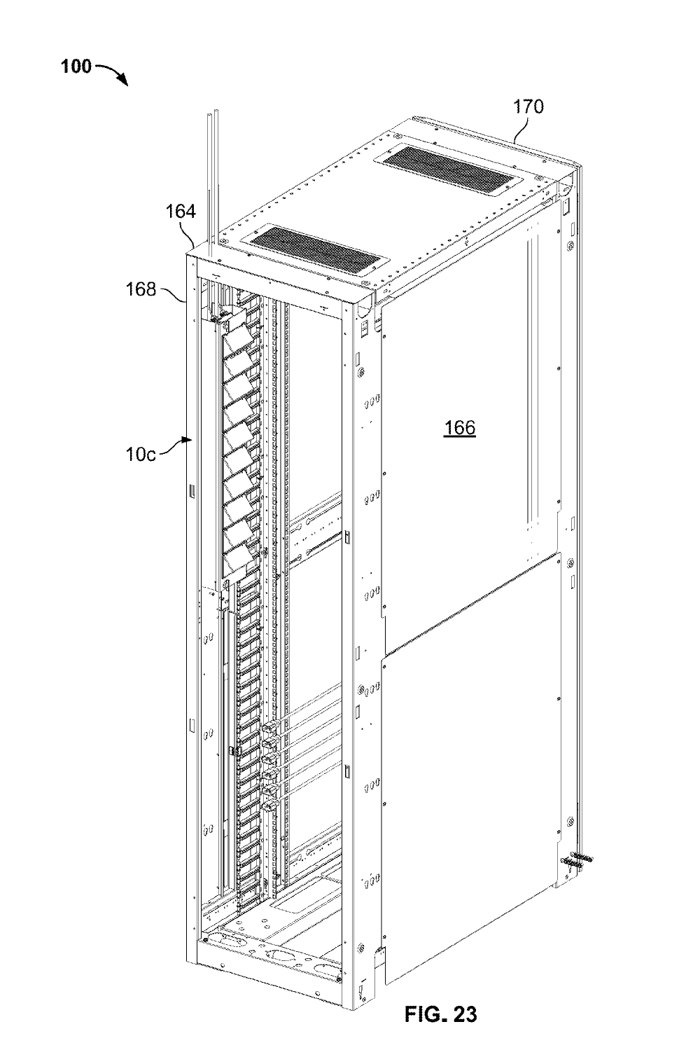

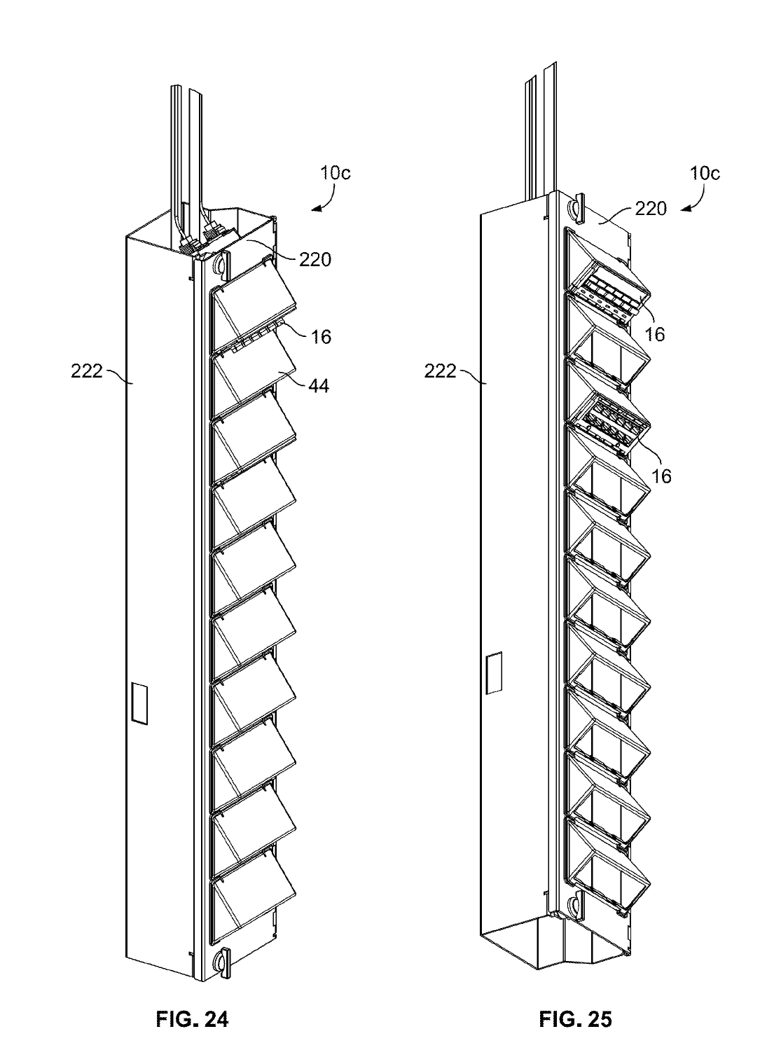

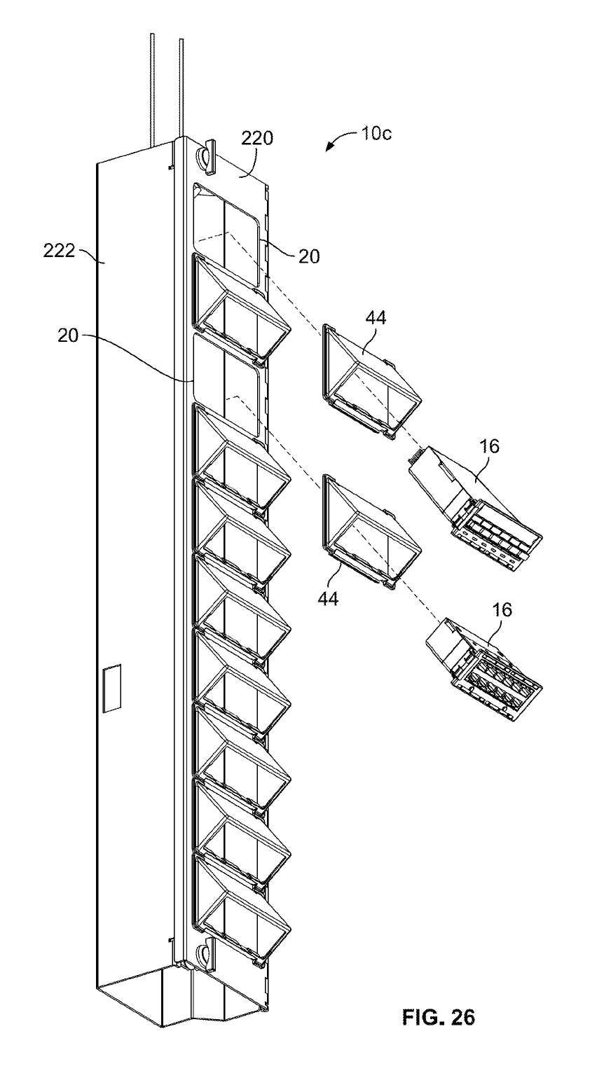

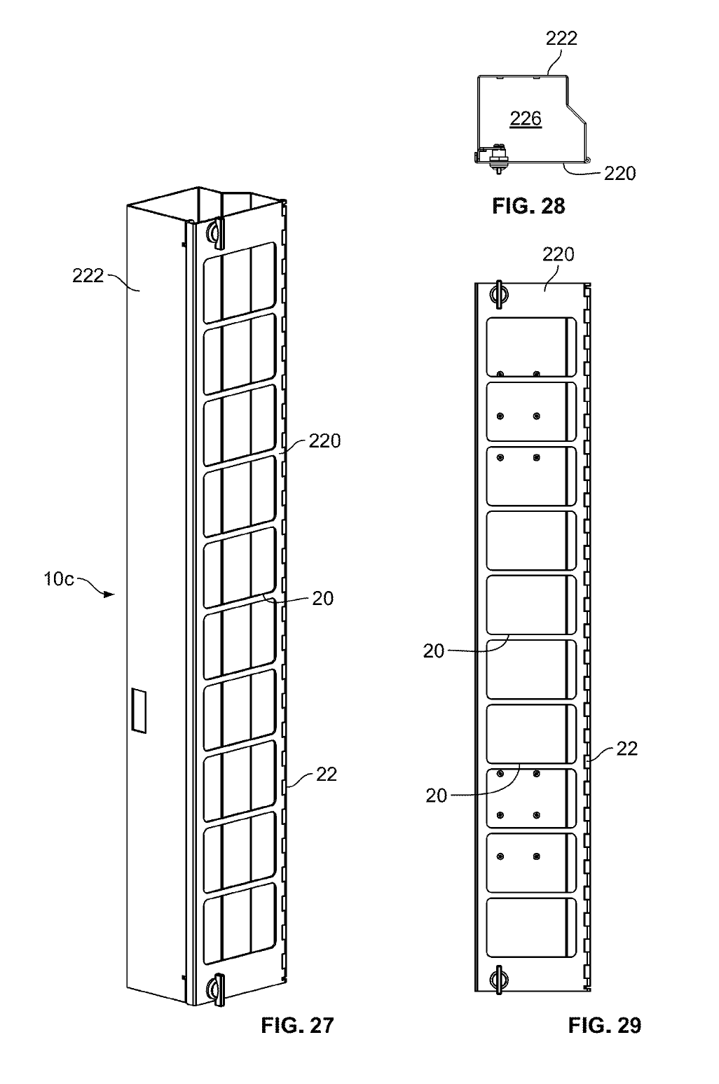

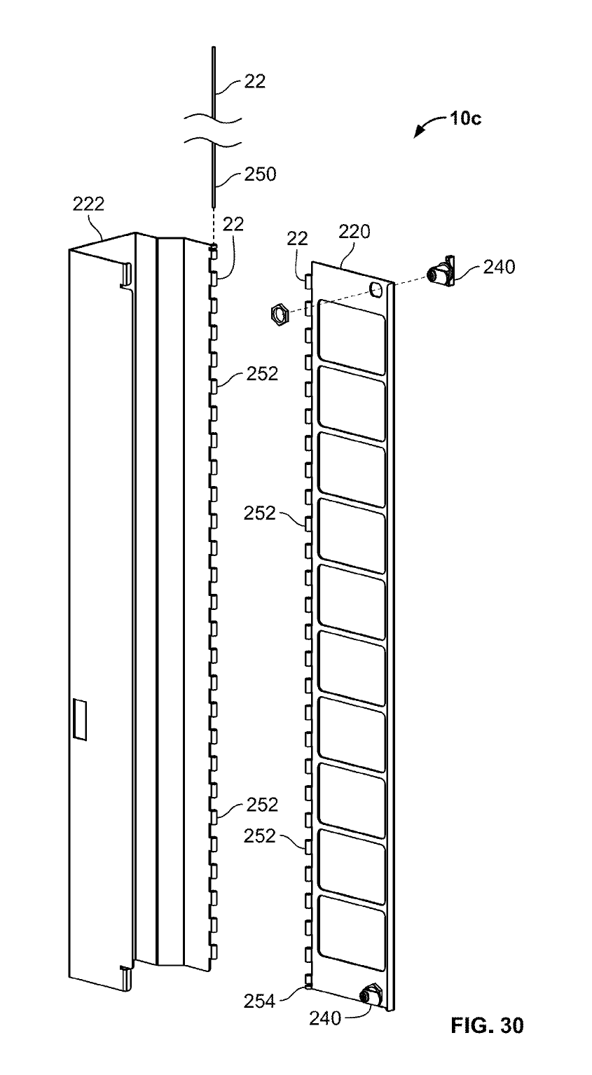

Referring to FIGS. 23-32, panel 10c can take the form of a standalone unit including a frame 220 hingedly mounted to a rear housing 222. Latches 240 can be provided to latch the panel in the closed position as shown in FIGS. 24-29. Mounting blocks 44 can be positioned in openings 20 in either orientation to angle modules 16 as desired. Blocks 44 snap into frame 220. During shipping, blocks 44 can be left separate and housed within the interior 226 of panel 10. Modules 16 can be shipped separately from blocks 44 and installed into blocks 44 after blocks 44 are mounted to frames 22, 220

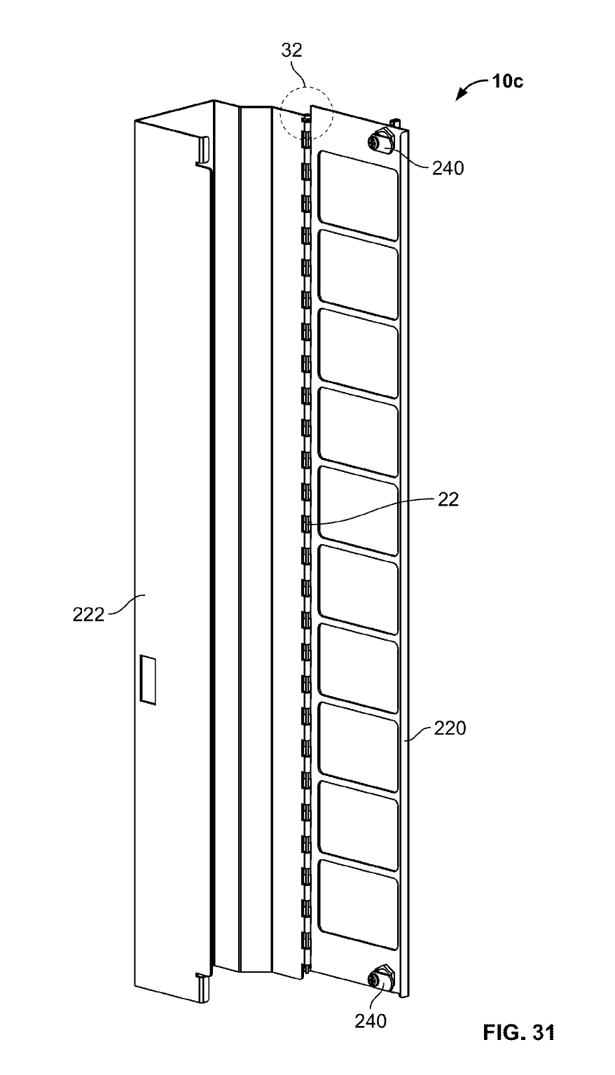

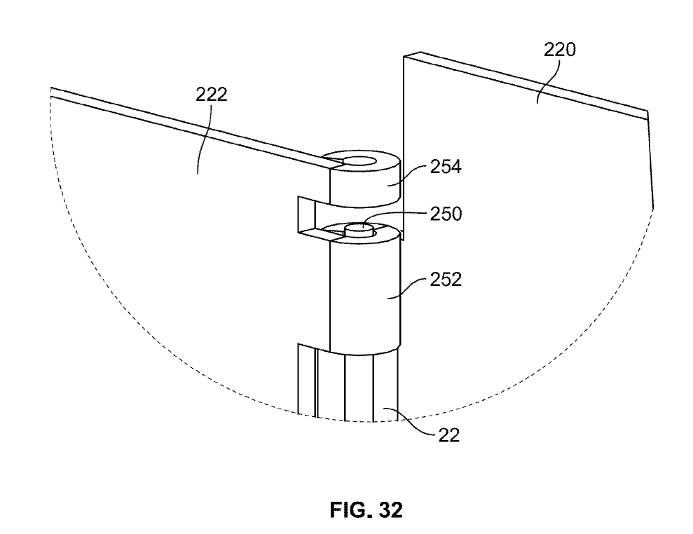

Panel 10 can be mounted to either side of the cabinet 100 by flipping the panel 180 degrees vertically. In the instance where all of the modules 16 are angled downwardly, the blocks 44 can be mounted to each respective frame 222 in the proper orientation for cable management. As shown in FIGS. 31 and 32, both the top and bottom of panel 10 can include a feature for the hinge which traps a hinge pin 250 in position. Once the hinge pin 250 is in the desired position between the hinge elements 252 of frame 220 and rear housing 222, and upper and lower elements 254 are crimped to prevent removal of the pin.

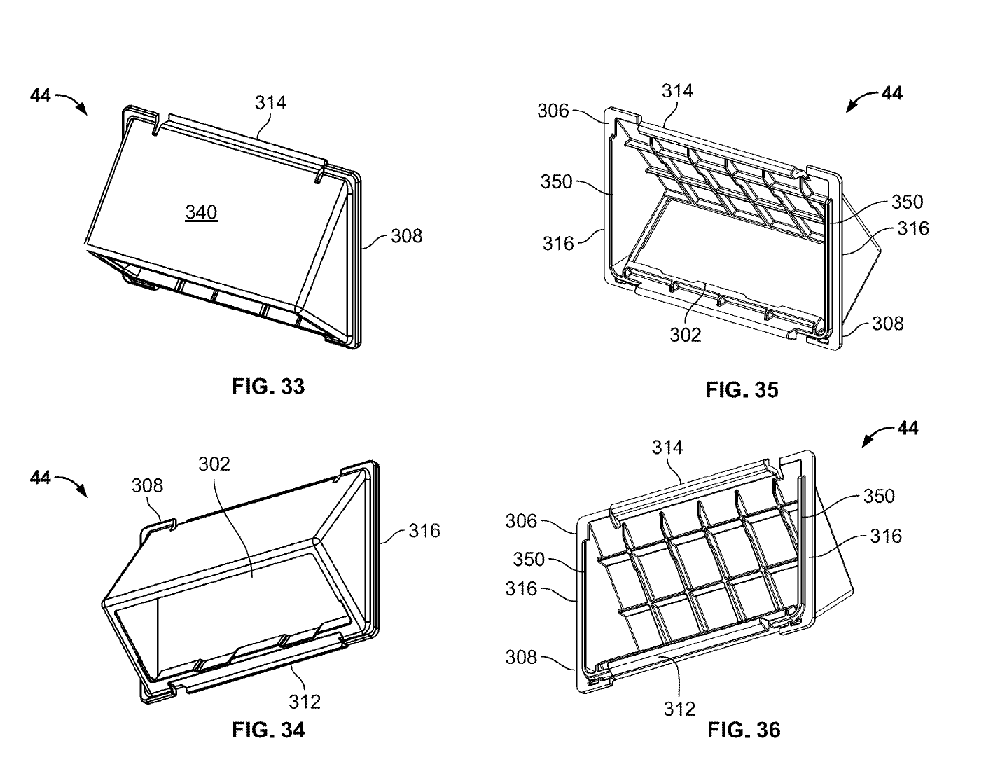

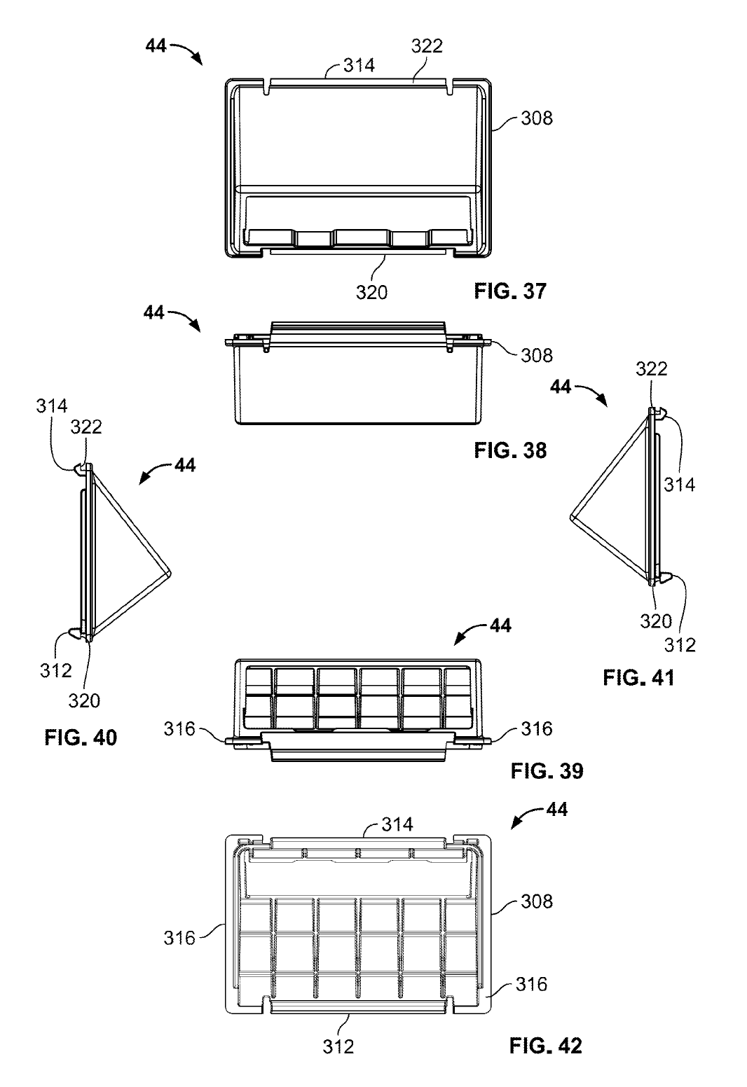

Referring now to FIGS. 33-42, further features of blocks 44 are shown. Blocks 44 hold modules 16 within an opening 302. Modules 16 will snap mount through a front of opening 302 to secure each module 16 to each block 44. Further, modules 16 are also removable from each opening 302 from the front of opening 302.

Each block 44 snap mounts to frame 12. On a rear portion 306 of each block 44 along a periphery 308 extends a first fixation device 312 and a second fixation device 314. Side portions 316 are also along periphery 308 of block 44. A shoulder 320 of first fixation device 312 is positioned on one side of frame 12 and side portions 316 are positioned on an opposite side of frame 12. Similarly, a shoulder 322 of second fixation device 314 is positioned on a rear side of frame 12.

Second fixation device 314 is flexible and allows for module mounting blocks 44 to be snap-fit to frame 12. Once a module 16 is positioned in a block 44, if the module 16 has a depth along surface 340, it may be difficult to remove or flex inward the second fixation device 314. Such a feature helps to secure blocks 44 in place. Along a rear of block 44 is a rib 350 which helps center each block 44 in each opening 20. Rib 350 defines a J-shape on each side of block 44 along each of side portions 316. Blocks 44 can be removed as desired, and in some cases modules 16 may need to be removed first.

What is claimed is:

1. A bracket assembly comprising:
a panel defining a plurality of openings extending between opposite first and second sides of the panel, the panel defining a hinge at one end; and
a plurality of termination modules, each termination module having a first port and/or termination and a second port and/or termination that faces in an opposite direction from the first port and/or termination, each termination module being mountable within one of the openings so that the first port and/or termination is accessible from the first side of the panel and the second port and/or termination is accessible from the second side of the panel, each of the termination modules being angled downwardly relative to the panel.

2. The bracket assembly of claim 1, wherein the first port and/or termination of each termination module is one of a plurality of first ports and/or termination.

3. The bracket assembly of any of claims 1 and 2, wherein the second port and/or termination of each termination module is one of a plurality of second ports and/or terminations.

4. The bracket assembly of any of claims 1-3, wherein the first port and/or termination is an optical port.

5. The bracket assembly of any of claims 1-3, wherein the first port and/or termination is an electrical termination.

6. The bracket assembly of any of claims 1-3, wherein the first port and/or termination is a hybrid termination including an optical port and an electrical termination.

7. The bracket assembly of any of claims 1-3, wherein the openings are aligned in a column.

8. The bracket assembly of claim 7, wherein the hinge extends parallel to the column.

9. The bracket assembly of any of claims 1-8, further comprising a block to mount one of the termination modules to the panel.

10. The bracket assembly of claim 9, wherein the block is one of a plurality of blocks that each mount a respective one of the termination modules to the panel.

11. The bracket assembly of any of claims 1-10, wherein a first sidewall extends rearwardly from the end of the panel and a second sidewall extends rearwardly from an opposite end of the panel so that the panel and sidewalls define a cable channel.

12. An equipment framework assembly comprising:
a framework having a front and an opposite rear that extend between a first side and an opposite second side and between a first end and an opposite second end;
telecommunications equipment mounted to the frame and accessible from the front of the frame;
a cable routing channel extending downwardly along the first side of the frame from the first end of the frame; and
a bracket assembly mounted to the framework at the cable routing channel, the bracket assembly including a panel that is pivotal relative to the cable routing channel between a closed position and an open position, the panel extending across at least part of the cable routing channel when in the closed position, the at least part of the cable routing channel being accessible when the panel is disposed in the open position, the panel carrying at least one termination module.

13. The equipment framework assembly of claim 12, wherein the cable routing channel is a vertical channel.

14. The equipment framework assembly of any of claims 12 and 13, wherein the cable routing channel has an open side through which the cable routing channel is accessible, the cable routing channel being oriented relative to the framework so that the open side faces one of the first and second sides of the equipment framework.

15. The equipment framework assembly of claim 14, further comprising patchcords routed between the termination module and the telecommunications equipment.

16. The equipment framework assembly of any of claims 12-15, wherein the telecommunications equipment includes active equipment.

17. The equipment framework assembly of any of claims 12-16, wherein the bracket assembly is the bracket assembly recited in any of claims 1-11.

18. The equipment framework assembly of any of claims 12-17, wherein the at least one termination module is an optical module.

19. The equipment framework assembly of any of claims 12-17, wherein the at least one termination module is an electrical module.

20. The equipment framework assembly of any of claims 12-17, wherein the at least one termination module is a hybrid module.

21. The equipment framework assembly of any of claims 12-20, wherein the framework includes a cabinet housing.

22. The equipment framework assembly of any of claims 12-20, wherein the framework includes a telecommunications rack.

23. The equipment framework assembly of any of claims 12-22, wherein the at least one termination module defines a first port and/or termination that faces the cable routing channel and a second port and/or termination that faces away from the cable routing channel.

24. The channel frame assembly of claim 23, wherein the at least one termination module is angled relative to the panel so that the second port and/or termination faces at least partially downwardly towards the second end of the frame.

25. The equipment framework assembly of any of claims 12-24, wherein the panel mounts to a frame mounted to an interior of the framework, the frame including a rear wall and sidewalls defining the cable routing channel.

26. A channel frame assembly comprising:
a frame including a rear wall, an open front, and opposite sidewalls extending between the rear wall and the open front to define a channel;
a bracket assembly mounted to the frame, the bracket assembly including a panel that pivots relative to the frame between a closed position and an open position, the panel covering the open front of the frame when in the closed position, the channel being accessible through the open front of the frame when the panel is in the open position; and
a termination module mounted to the panel, the termination module having at least a first port and/or termination that faces in a first direction and at least a second port and/or termination that faces in a second direction, the first port and/or termination being accessible from the channel and the second port and/or termination not being accessible from the channel when the panel is disposed in the closed position.

27. The channel frame assembly of claim 26, wherein the second port and/or termination is accessible through the open front of the frame and the first port and/or termination is not accessible through the open front of the frame when the panel is disposed in the closed position.

28. The channel frame assembly of any of claims 26 and 27, wherein the termination module is an optical module.

29. The channel frame assembly of any of claims 26 and 27, wherein the termination module is an electrical module.

30. The channel frame assembly of any of claims 26 and 27, wherein the termination module is a hybrid module.

31. The channel frame assembly of any of claims 26-30, wherein the termination module is one of a plurality of termination modules carried by the panel.

32. The channel frame assembly of claim 31, wherein the termination modules are aligned in a column.

33. An equipment framework assembly comprising:
an equipment framework defining an open front;
telecommunications equipment accessible through the open front of the equipment framework; and
at least one channel framework assembly as recited in any of claims 26-32 mounted to the equipment framework to define a cable routing passage through the equipment framework.

34. The equipment framework assembly of claim 33, wherein the equipment framework includes a cabinet.

35. The equipment framework assembly of claim 33, wherein the equipment framework includes a rack.

36. The equipment framework assembly of any of claims 33-35, wherein the telecommunications equipment has ports and/or terminations facing the open front of the equipment framework; and wherein the open front of the frame of the at least one channel framework is oriented at a 90° angle relative to the open front of the equipment framework.

37. The equipment framework assembly of any of claims 33-36, further comprising a second channel framework assembly as recited in any of claims 26-32 mounted to an opposite side of the equipment framework from the at least one channel framework assembly.

38. A telecommunications panel comprising:
a frame defining a top, an opposite bottom, a front, an opposite back, and two sides, and a main panel member;
a plurality of openings from the front to the back through the main panel member;
a hinge extending one of the sides defining a hinge axis extending in a direction between the top and the bottom;
a plurality of modules mounted in the openings, each module defining one or more front ports or termination locations, and one or more rear ports or termination locations.

39. A telecommunications cabinet including the panel of claim 38 and further comprising:
a frame structure defining a top, an opposite bottom, a front, an opposite back, and opposite sides;
telecommunications equipment mounted to the telecommunications cabinet wherein the telecommunications equipment is accessible from at least one of the front or the back of the telecommunications cabinet.

40. The telecommunications panel and/or cabinet of claims 38 and 39, further comprising a plurality of patch cords extending from the front ports of the telecommunications modules, and extendable to telecommunications equipment of a telecommunications cabinet.

41. The telecommunications panel and/or cabinet of claims 38-40, further comprising one or more trunk cables extending to the rear ports of the telecommunication modules.

42. The telecommunications panel and/or cabinet of claims 38-41, wherein the modules are positioned at an angle relative to the frame of the panel wherein a connection axis of the front ports or the rear ports is at an angle relative to a horizontal plane and a vertical plane.

43. The telecommunications panel and/or cabinet of claims 38-42, wherein one or more of the modules extend rearwardly from the frame more than a rearmost portion of the frame.

44. The telecommunications cabinet of claims 39-43, wherein the cabinet defines a cable passage which faces a back side of the frame of the panel when the panel is in a closed position, and wherein the cable passage is exposed, when the panel is hinged to an open position.

45. The telecommunications panel and/or cabinet of claims 38-44, wherein a rear housing is mounted to the frame along a hinge to form a closed interior, and wherein the rear housing can be mounted to a cabinet or other structure.

46. The telecommunications panel and/or cabinet of claims 38-45, wherein blocks snap to the frame in the openings of the main panel member, wherein the modules snap to the blocks.
